(19) United States
(12) Patent Application Publication
(10) Pub. No.: US 2016/0349389 A1
(43) Pub. Date: Dec. 1, 2016

(54) METHOD FOR DEVELOPING A GEOMECHANICAL MODEL BASED ON SEISMIC DATA, WELL LOGS AND SEM ANALYSIS OF HORIZONTAL AND VERTICAL DRILL CUTTINGS

(71) Applicant: CGG SERVICES SA, Massy (FR)

(72) Inventors: Dale WALTERS, Calgary (CA); Vikram SEN, Calgary (CA); Robert MAYER, Houston, TX (US); Graham SPENCE, Conwy (GB); Antonin SETTARI, Calgary (CA)

(21) Appl. No.: 15/165,352

(22) Filed: May 26, 2016

Related U.S. Application Data
(60) Provisional application No. 62/168,003, filed on May 29, 2015.

(51) Int. Cl. G01V 1/28; G06F 17/18; G01V 1/40

(52) U.S. Cl. CPC G01V 1/282; G01V 1/40; G06F 17/18

(57) ABSTRACT

A model of geomechanical properties in an underground volume including an oil and/or gas reservoir is obtained using seismic data acquired with sensors placed to probe the underground reservoir, well logs of wells drilled inside the underground volume, and composition information of horizontal, deviated and vertical drill cuttings from the wells. The composition information is used to calibrate the well logs, which are then employed to improve models obtained from the seismic data.

### CROSS REFERENCE TO RELATED APPLICATIONS

This application claims priority and benefit from U.S. Provisional Patent Application No. 62/168,003, filed May 29, 2015, for “Seismic to Simulation Workflow and Process,” the entire contents of which is incorporated herein by reference.

### TECHNICAL FIELD

Embodiments of the subject matter disclosed herein generally relate to methods and systems for evaluating geology around an oil and gas reservoir and predicting its evolution during production using seismic data, well logs and leptonic or baryonic beam scanning of drill cuttings.

### BACKGROUND

Seismic surveys are frequently used in the oil and gas industry to locate and monitor underground oil and gas reservoirs. Additionally, at a production site wells are drilled for exploration or production. Well logs record values of geophysical properties (e.g., lithology, porosity, water saturation, permeability, etc.) as functions of depth. The well logs may contain information acquired using various logging instruments. Additionally, drill cutting samples in vertical sections may be collected as frequently as every ½ foot to 1 foot, to be later analyzed to provide more information about rock mineralogy, rock fabric and geomechanical properties.

Recently, new technologies have been developed allowing oil and gas recovery from new types of reservoirs. For example, hydraulic fracturing (also known as fracking) involves high-pressure injection of fluid into a well passing through a formation in which oil, gas and petroleum reservoirs are trapped, creating cracks that allow the trapped oil, natural gas and petroleum to flow and be recovered. The efficiency of hydraulic fracturing depends on geomechanical properties in the target formation. Additionally, this method of extracting oil and gas results in local changes of the geomechanical properties. It has thus become more important to obtain more accurate knowledge of geomechanical properties in an underground volume including an oil and/or gas reservoir to be able to predict its evolution during production.

### SUMMARY

In order to obtain a more accurate model of geomechanical properties in an underground volume including an oil and/or gas reservoir, composition information of horizontal and vertical drill cuttings from the wells is used to calibrate wells data, which is then employed in seismic data inversion and to improve multi-variant statistical analysis results.

According to an embodiment, there is a method for modeling geomechanical properties in an underground volume including an oil and/or gas reservoir. The method includes obtaining seismic data acquired with sensors placed to probe the underground volume, well logs of wells drilled inside the underground volume, and composition information of horizontal, deviated and vertical drill cuttings from the wells, calibrating the well logs using the composition information of horizontal, deviated and vertical drill cuttings from the wells yielding calibrated well logs, generating an initial structural model of the underground volume based on the calibrated well logs and inverting the seismic data using the initial structural model to determine values of elastic properties inside the underground volume. The method further includes performing a multi-variant statistical analysis using the values of the elastic properties to generate a three-dimensional, 3D, seismic-based mechanical-properties model of the underground volume, and tuning the 3D seismic-based mechanical-properties model using the calibrated well logs and composition information of the horizontal drill cuttings.

According to another embodiment, there is a computer-readable medium containing computer-executable code that when read by a computer causes the computer to perform a method for modeling geomechanical properties in an underground volume including an oil and/or gas reservoir. The method includes obtaining seismic data acquired with sensors placed to probe the underground volume, well logs of wells drilled inside the underground volume, and composition information of horizontal, deviated and vertical drill cuttings from the wells, calibrating the well logs using the composition information of horizontal, deviated and vertical drill cuttings from the wells yielding calibrated well logs, generating an initial structural model of the underground volume based on the calibrated well logs and inverting the seismic data using the initial structural model to determine values of elastic properties inside the underground volume. The method further includes performing a multi-variant statistical analysis using the values of the elastic properties to generate a three-dimensional, 3D, seismic-based mechanical-properties model of the underground volume, and tuning the 3D seismic-based mechanical-properties model using the calibrated well logs and composition information of the horizontal drill cuttings.

According to yet another embodiment, there is system for designing an oil and gas recovery including a seismic survey arrangement, drilling equipment, and a seismic data processing apparatus. The seismic survey arrangement is configured to acquire seismic data related to the underground volume. The drilling equipment is configured to drill wells inside the underground volume and to retrieve horizontal, deviated and vertical drill cuttings at predetermined locations. The seismic data processing apparatus is configured to obtain the seismic data, well logs of the wells and composition information of the horizontal, deviated and vertical drill cuttings, to process the seismic data using the well logs calibrated based on the composition information to generate a 3D seismic-based mechanical properties model of the underground volume, and to predict evolution of structure and properties inside the underground volume, for different oil and/or gas production scenarios using the 3D seismic-based mechanical model. The manner of recovering the oil and gas is designed using results predicted for the different oil and/or gas production scenarios.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flowchart of a method for modeling geomechanical properties in an underground volume according to an embodiment;

FIG. 2 is a graphic representation of gather conditioning;

FIG. 3 is graphs illustrating seismic data before gather conditioning, after gather conditioning, and the difference between the seismic data before and after gather conditioning;

FIG. 4 illustrates a source-emitted spectrum;

FIG. 5 illustrates a reflectivity spectrum;

FIG. 6 illustrates a seismic data spectrum;

FIG. 7 is a graphic illustration of incident energy transformation at an interface;

FIG. 8 is a generic illustration of the seismic inversion;

FIG. 9 illustrates the effect of stochastic inversion;

FIG. 10 illustrates results of stochastic inversion;

FIG. 11 illustrates a training process in multi-variant analysis;

FIG. 12 illustrates multi-variant analysis results;

FIG. 13 illustrates total porosity results obtained from multi-variant analysis results;

FIG. 14 illustrates VShale obtained by multi-variant analysis;

FIG. 15 illustrates effective porosity obtained by multi-variant analysis;

FIG. 16 illustrates water saturation obtained by multi-variant analysis;

FIG. 17 exemplifies drill-cutting composition information;

FIG. 18 shows the impact of the more accurate and dense information provided by the calibrated well log and horizontal drill cuttings;

FIG. 19 is a schematic illustration of 3D coupled flow and geomechanical simulations;

FIG. 20 is a data flow diagram according to an embodiment; and

FIG. 21 is a diagram of a system for studying oil and gas recovery from an underground volume including an oil and/or gas reservoir according to an embodiment.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. For simplicity, some of the following embodiments are discussed for land seismic survey. However, the embodiments to be discussed next are not limited to land surveys, but may be extended to reservoirs beneath a body of water.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

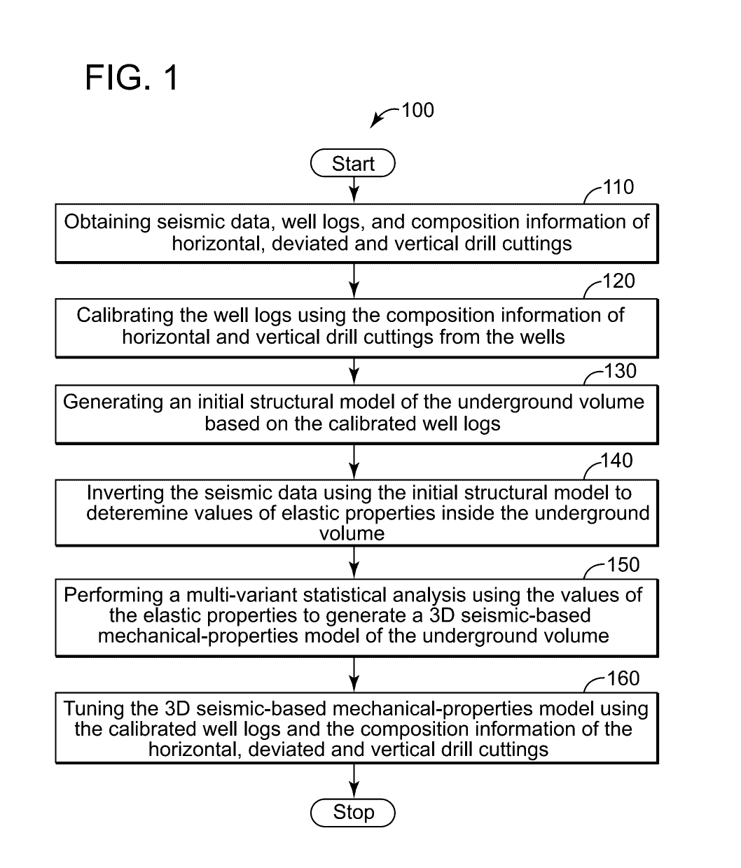

A flowchart of a method 100 for modeling geomechanical properties in an underground volume is illustrated in FIG. 1. Method 100 is typically applied to an underground volume including an oil and gas reservoir, but it is not to be limited by requiring the presence of a reservoir. At 110, method 100 includes obtaining:
seismic data acquired with sensors placed to probe (e.g., above) the underground volume,
well logs of wells drilled inside the underground volume, and
composition information of horizontal, deviated (i.e., neither vertical nor horizontal) and vertical well drill cuttings.

Seismic data includes seismic source and seismic receiver locations, emitted seismic excitation information, and seismic receiver amplitude-versus-time recordings. At least one seismic source generates seismic excitations that penetrate the underground volume to be reflected, refracted and transmitted therein. A part of the energy emitted as seismic excitations is then received by the seismic receivers. The amount of energy detected by the receivers and its arrival time carries information about the geological structure of the underground formation and its elastic properties (i.e., propagation velocities of compression and shear waves in different layers, density, location of interfaces between layers, etc.).

The well logs provide information about geophysical properties as functions of depth at well locations. Drill-cutting samples are also collected while the wells are drilled. Besides drill-cutting samples corresponding to vertical sections, drill-cutting samples in horizontal and deviated sections are also collected, for example, typically every 10 to 30 feet. The collected samples are analyzed to determine various physical characteristics, including mineral composition and texture which includes rock fabric and porosity, including the shape and size of the pores. These characteristics may be obtained by irradiating the samples with an electromagnetic (EM), baryonic or leptonic beam to then measure the scattered EM, baryonic or leptonic output due to the samples' interaction with the incident beam. A comprehensive sample analysis known as scanning electron microscopy (SEM) may be performed using an electron microscope. The information obtained from drill-cuttings sample analysis is collectively named “composition information.”

Returning now to FIG. 1, method 100 further includes calibrating the well logs using the composition information of horizontal, deviated and vertical drill cuttings from the wells, at 120. That is, the geophysical properties as functions of depths acquired using logging instruments are refined and calibrated using the more accurate and detailed information resulting from drill-cuttings analysis. In particular, conventionally, information provided by drill cuttings in horizontal sections has not been systematically acquired and used.

Method 100 further includes generating an initial structural model of the underground volume based on the calibrated well logs, at 130. This initial structural model is based on measurements acquired along the wells.

Method 100 further includes inverting the seismic data using the initial structural model to determine values of elastic properties inside the underground volume at 140. The inversion (which is usually iterated few times) is described in more detail later in this document.

Method 100 then includes performing a multi-variant statistical analysis using the values of the elastic properties to generate a three-dimensional (3D) seismic-based mechanical properties model of the underground volume at 150. The multi-variant statistical analysis is also described in more detail later in this document.

Finally, method 100 includes tuning the 3D seismic-based mechanical properties model using the calibrated well logs and the composition information of the horizontal, deviated and vertical drill cuttings from the wells at 160.

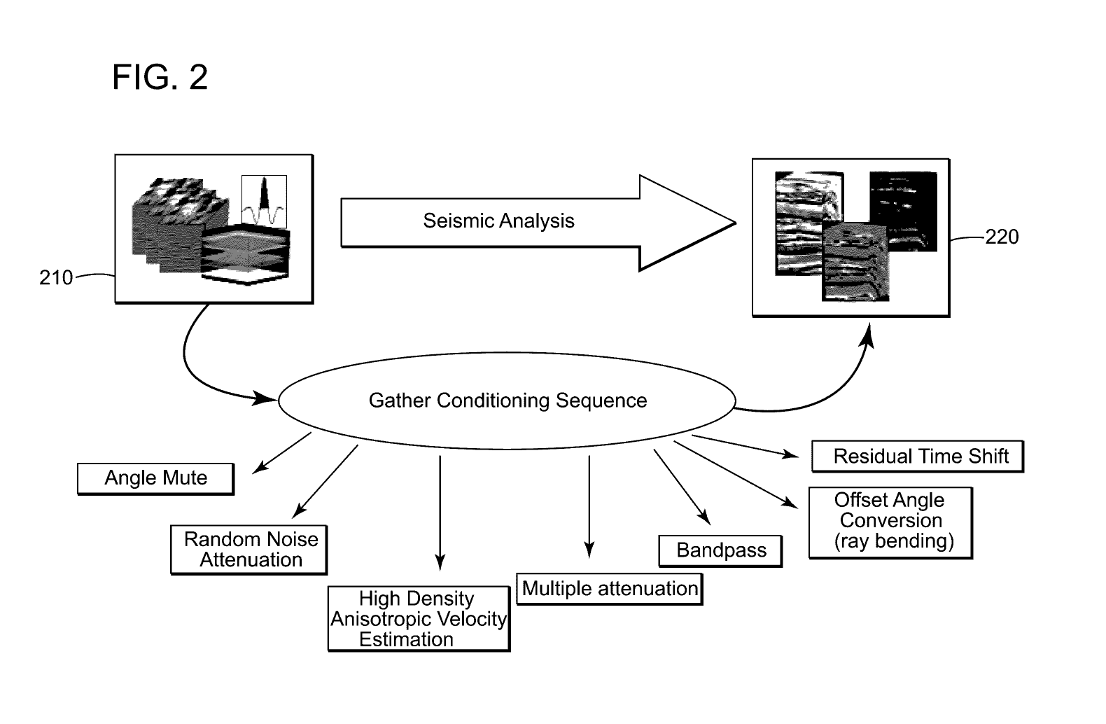

Before the inverting, seismic data may be pre-stacked (in time or depth), migrated and subjected to seismic gather conditioning. FIG. 2 is a graphical illustration of gather conditioning. Rectangle 210 illustrates the seismic gather conditioning input, and rectangle 220 illustrates the seismic gather conditioning output.

The three overlapping cubes in 210 are stacks of data corresponding to near, middle and far traces, grouped according to source-to-receiver distances. The layered cube in 210 is a basic structure model used during gather conditioning. This basic structure model may be inferred from the well logs. The graph in rectangle 210 represents a wavelet, thereby suggesting the seismic excitation that caused the receiver-detected seismic data.

Gather conditioning may include one or more of the following techniques: angle muting, random noise attenuation, high-density anisotropic velocity estimation, multiples attenuation, filtering, offset angle conversion, and residual time shift. This sequence of techniques is exemplary, and not intended to be limiting in terms of possible techniques or order of applying the techniques. The graphs in rectangle 220 represent amplitudes (i.e., nuances of gray) in vertical slices (time versus distance, i.e., range limited volumes) corresponding to the near, middle and far groups of traces.

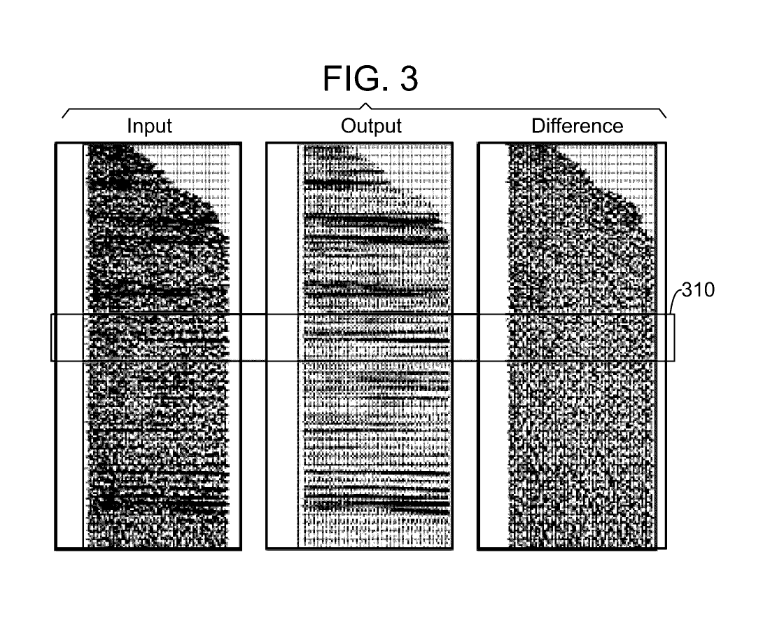

Thus, seismic gather conditioning attenuates coherent or incoherent noise, removes multiples and converts the recorded time dependence to honor true time offset event relationships, while preserving or restoring the amplitude-versus-offset or amplitude-versus-angle relationships. Seismic gather conditioning is performed with care to preserve the signal (i.e., information about the underground structure). FIG. 3 includes three graphs of amplitude (nuances of gray) in a time-versus-offset slice for gather conditioning input data on the left, gather conditioning output data in the middle, and their difference on the right. Rectangle 310 emphasizes corresponding signal areas in these three graphs.

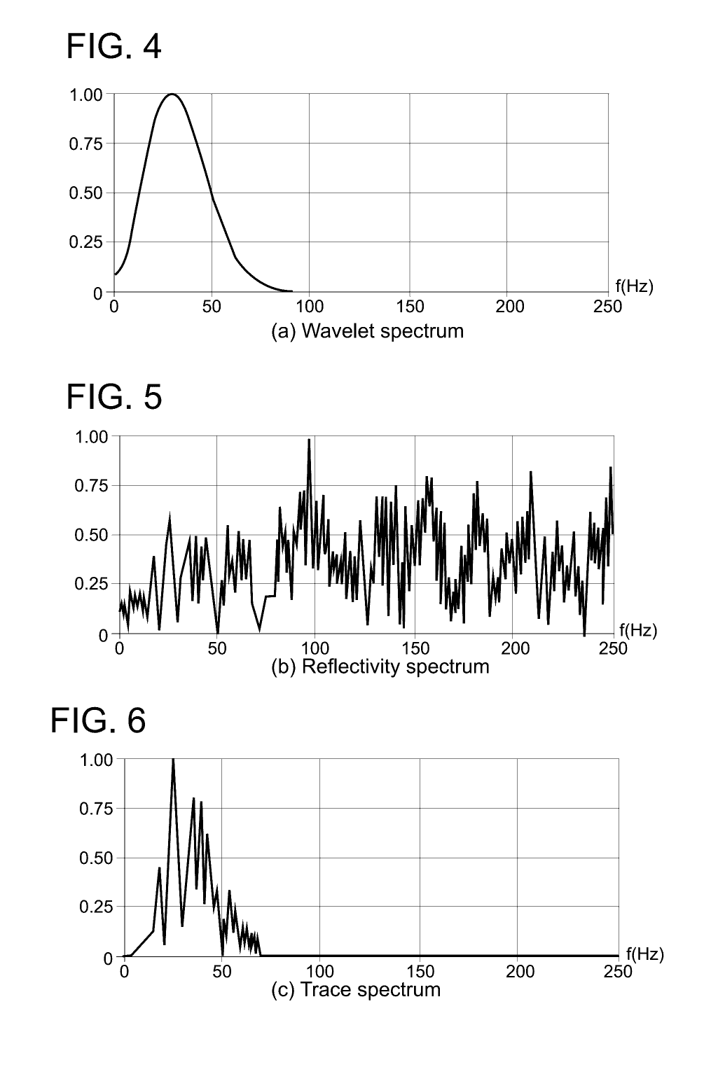

Seismic inversion is the process of deriving a model to describe the underground formation that is consistent with the seismic data. When seismic data is acquired, the underground formation filters the original seismic excitation, removing both low and high frequency from the original signal. FIG. 4 illustrates a source-emitted spectrum (normalized amplitude versus frequency), FIG. 5 illustrates a reflectivity spectrum, and FIG. 6 illustrates a resulting seismic data spectrum. The resulting seismic data spectrum is depleted for the high and low frequencies.

Starting from a reasonable initial model of the underground structure and an estimate of the source-emitted excitation (i.e., wavelet), inversion methods yield values of elastic properties inside the underground formation. The initial model may be generated using density and impedance values from the well logs. The well logs may have been calibrated according to drill-cutting samples analysis (e.g., SEM mineralogical analysis). The initial model may thus be calibrated using standard rock physics techniques that relate mineralogy, rock fabric and pore fluids to elastic parameters.

Many seismic inversion methods are available. Some methods that start from post-stack seismic data (known as pre-stack seismic inversions) yield acoustic impedance, shear impedance, and density values utilizing the relationships defined in the Zoeppritz equations. These relationships describe how seismic energy is partitioned at a geological boundary. Both pre-stack and post-stack inversions can utilize a deterministic or stochastic approach. A deterministic inversion finds the single best earth model that can describe the seismic response. Stochastic inversion creates a number of high-resolution models of impedance, using geostatistical techniques. Assuming that each model is equally probable, probability and uncertainty of the elastic properties values may be evaluated.

Pre-stack inversion methods generate a model of the underground formation, that is, define volumes of substantially constant elastic properties separated by interfaces from other such substantially constant elastic properties volumes therein. In order to achieve such results, the seismic data is constrained using well logs, source-related information allowing extraction of the excitation signature for deconvolution, and a low-frequency model to be created of the missing frequency content from the seismic bandwidth. Pre-stack inversion is designed to invert seismic data of pre-stack time migration (PSTM) or pre-stack depth migration (PSDM) angle gathers or multiple angle stacks, yielding an initial model of acoustic impedance, shear impedance, and density. This model may be generated utilizing seismic transmission-reflectivity relationships defined in Zoeppritz equations.

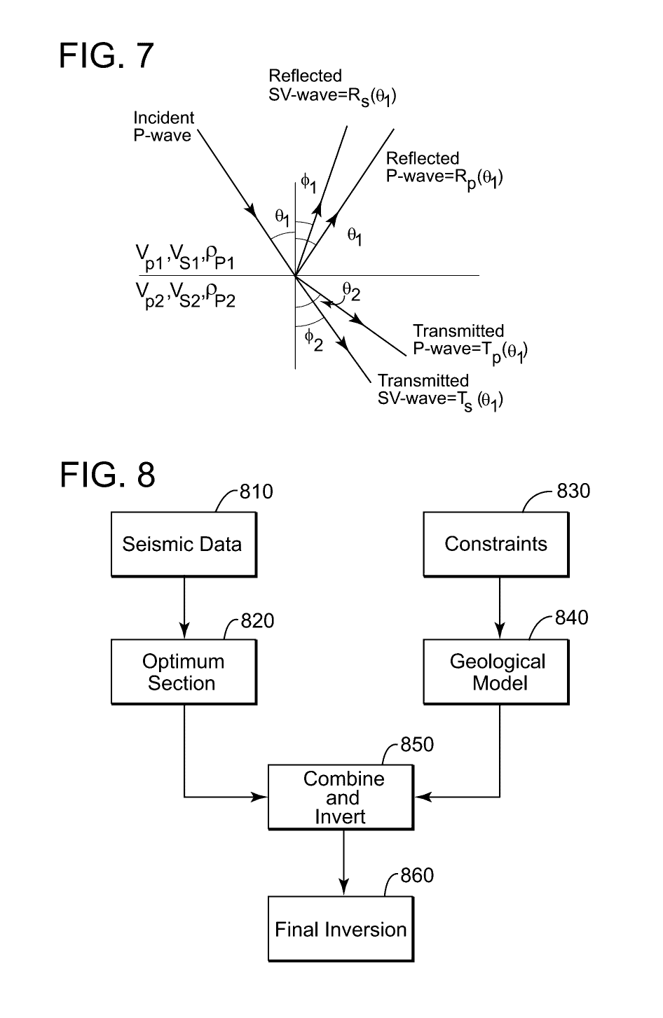

As illustrated in FIG. 7, at each geologic interface, incident P-wave energy is transmitted and reflected. The relationship of incident P-wave energy to reflective P-wave energy at different angles can give rise to the changes in VP, VS and density between volume boundaries, and it is the basis for pre-stack inversion.

There are several linearized approximations that simplify the original Zoeppritz equations. The Aki-Richards equation below is written in a more intuitive sense and is the basis for amplitude-versus-offset (AVO) and pre-stack inversion methods:

$$R ( θ ) = {aR}_{VP} + {bR}_{VS} + {cR}_{D} \\ where {R}_{VP} = \frac{Δ {V}_{P}}{2 {\overline{V}}_{P}} , {R}_{VS} = \frac{Δ {V}_{S}}{2 {\overline{V}}_{S}} , {R}_{D} = \frac{Δρ}{2 \overline{ρ}} , \\ a = 1 + {tan}^{2} θ , b = - 8 K {sin}^{2} θ , \\ c = 1 - 4 K {sin}^{2} θ and K = {( \frac{{\overline{V}}_{s}}{{\overline{V}}_{P}} )}^{2} . \qquad ( 1 )$$

Equation (1) defines that the total reflectivity R and any angle θ can be calculated as the weighted sum of relative changes in the compression velocity V_{P}, shear velocity V_{S}, and density ρ. Acoustic impedance (where the impedance is the product of density and velocity, and the term “acoustic” indicates compression) and shear impedance models are well-constrained and are a common output from all pre-stack inversions. Density, however, is only correctly obtained in a pre-stack inversion with clean high-angle seismic gathers. Since these criteria are rarely met for onshore shale seismic surveys, density must often be estimated with other procedures.

FIG. 8 is a schematic representation of an inversion method.

Seismic data 810 is selected, for example, to yield an optimum section 820. Constraints 830 (e.g., well logs) are converted and extrapolated, if necessary, to generate an initial geological model 840. Selected seismic data 820 and geological model 840 are combined at 850 to assess where and how much the model agrees with the seismic data. The model is then enhanced iteratively until a final inversion 860 that is based on the best achievable model in current conditions.

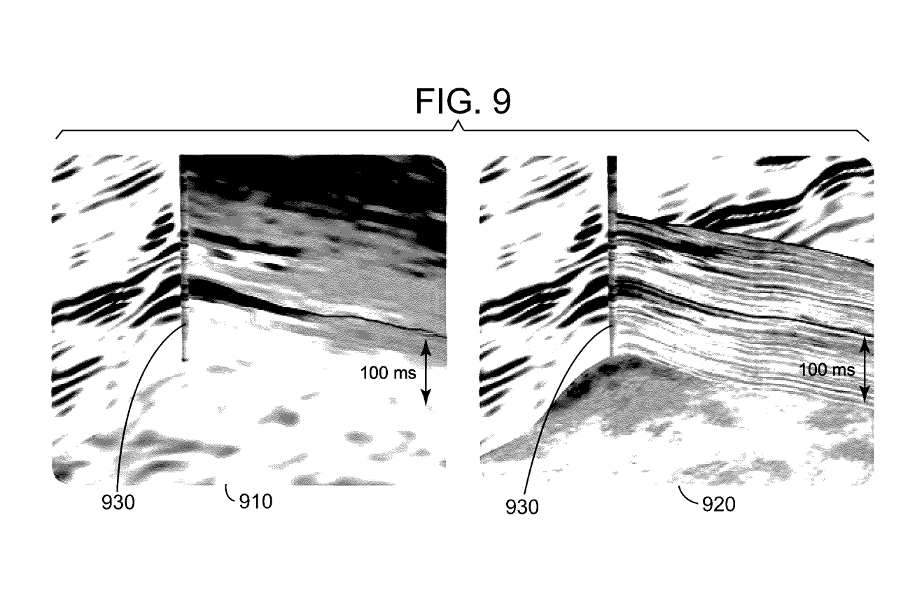

Stochastic pre-stack inversion is an inversion method based on plural high-frequency stochastic models, yielding high-resolution reservoir characterization and uncertainty analysis. Stochastic pre-stack inversion addresses the band-limited nature of deterministic inversion methods and integrates well data and seismic data at a fine scale within a stratigraphic geo-model framework. FIG. 9 illustrates the difference between a single deterministic inversion 910 and a single realization of a stochastic inversion outcome 920 for the same seismic data, with the nuances of gray corresponding to acoustic impedance and the graphs representing three planes having a well 930 (and thus a well-logs-constraint solution) along the z axis.

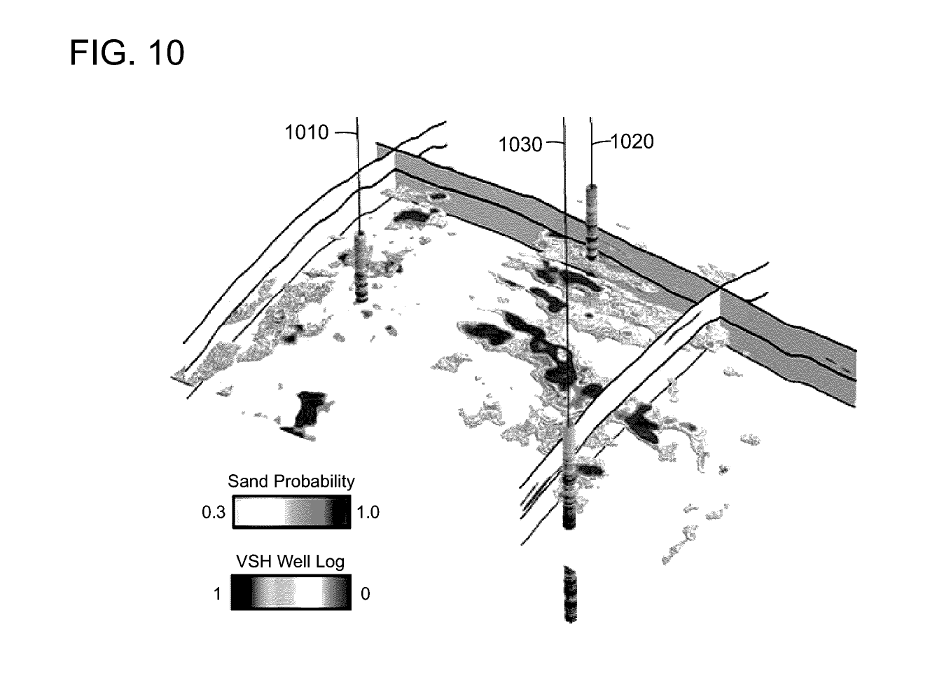

Multiple high-resolution solutions generated by stochastic inversion can be used in a geomechanical simulation workflow, following each inversion. This approach maximizes the stochastic inversion's potential, reducing the risk associated with interpretation, and leads to more accurate assessment of potential reserve and areas of focus for geomechanical simulation and analysis. For example, FIG. 10 illustrates, as nuances of gray, sand probability in a cross-section, while probability of the rock being shale (VSH) according to well logs is represented for wells 1010, 1020 and 1030 therein.

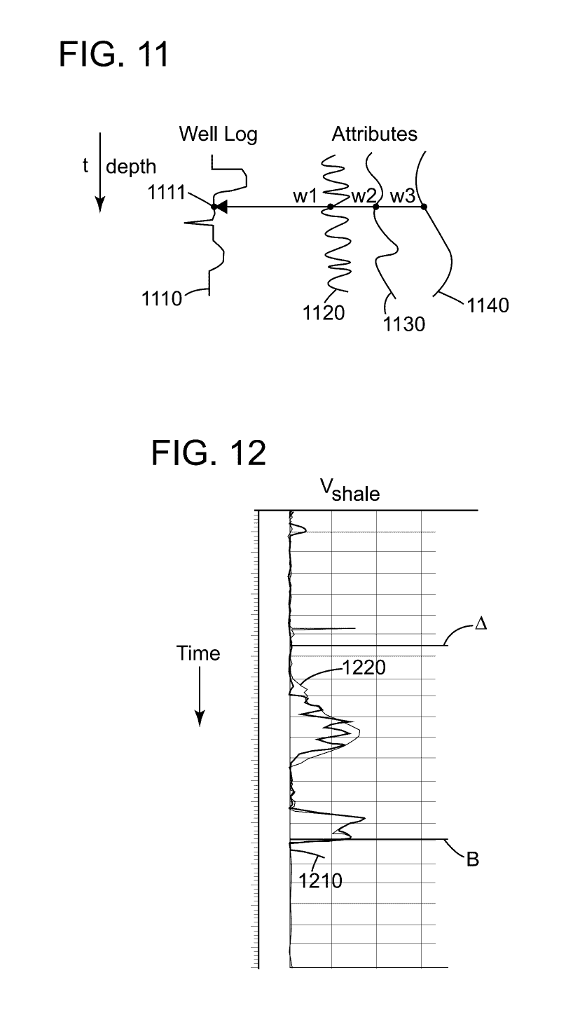

Further, multiple multi-variant analysis is performed based on the well logs and inversion solution. Seismic attributes (e.g., amplitude, compression and shear velocities, density and their derivatives, product, etc.) are used to estimate log and reservoir properties away from wells using a statistical methodology that trains a set of seismic attributes to predict reservoir properties using multi-linear and neural network transforms. FIG. 11 illustrates this training process in an intuitive and simplified manner. A property (e.g., the probability the rock is shale, VSH), which has an evolution 1110 measured and recorded in a well log, is described using three attributes 1120, 1130 and 1140 as obtained from inversion of seismic data. A measurement of the property at a location 1111 is described using a weighted sum of seismic attributes at the w1, w2 and w3 same time (or depth). With potentially dozens of seismic amplitude, velocity and inversion attributes, multi-variant geostatistical processes can be employed to predict meaningful reservoir and geomechanical properties away from the wells. Predicted properties may include mineral percentage, volumetrics, Total Organic Carbon TOC, porosity, permeability, water saturation, Poisson's ratio, Young's Modulus, and pore pressure away from the well bore.

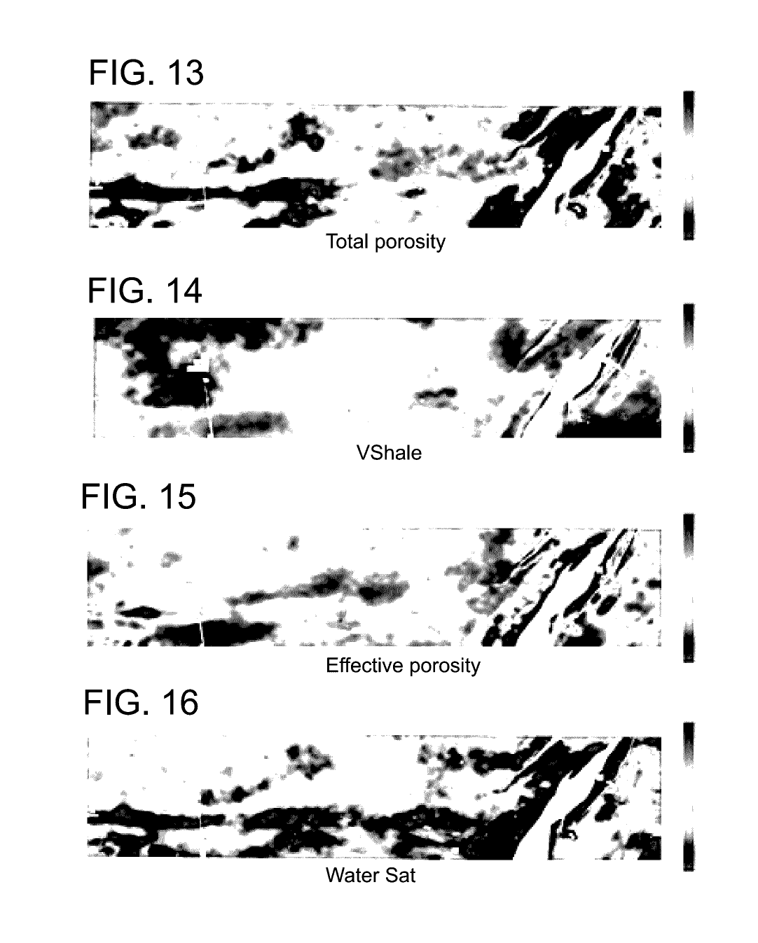

FIG. 12 illustrates multi-variant analysis results. The continuous line 1210 corresponds to VShale as measured (i.e., from the well logs), and the dashed line 1220 is VShale as predicted using multi-variant analysis from the seismic data. Lines A and B mark the top and bottom of focus area over which analysis has been conducted. Once the relationship between the property and the attributes is validated (e.g., for multiple wells), it can be applied to the full underground formation explored with seismic excitations, essentially evaluating that property over the whole volume. FIGS. 13, 14, 15 and 16 illustrate total porosity, probability of the formation being shale (VShale), effective porosity and water saturation in vertical slices through the underground formation, with the properties values (whose variation is represented by the different nuances of gray) being obtained using attribute values in the combination resulting from the multiple attribute analysis. The result of the multi-variant statistical analysis is a 3D seismic-based mechanical properties model.

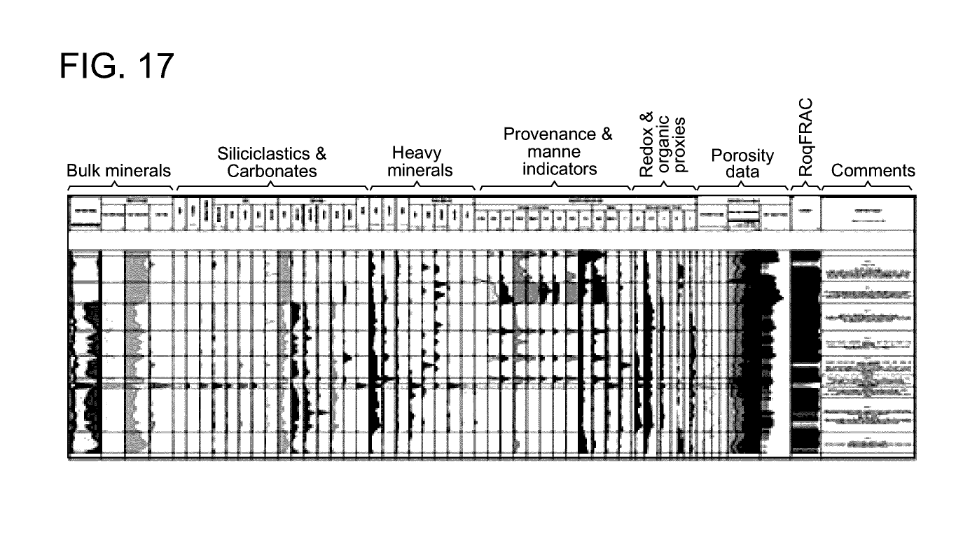

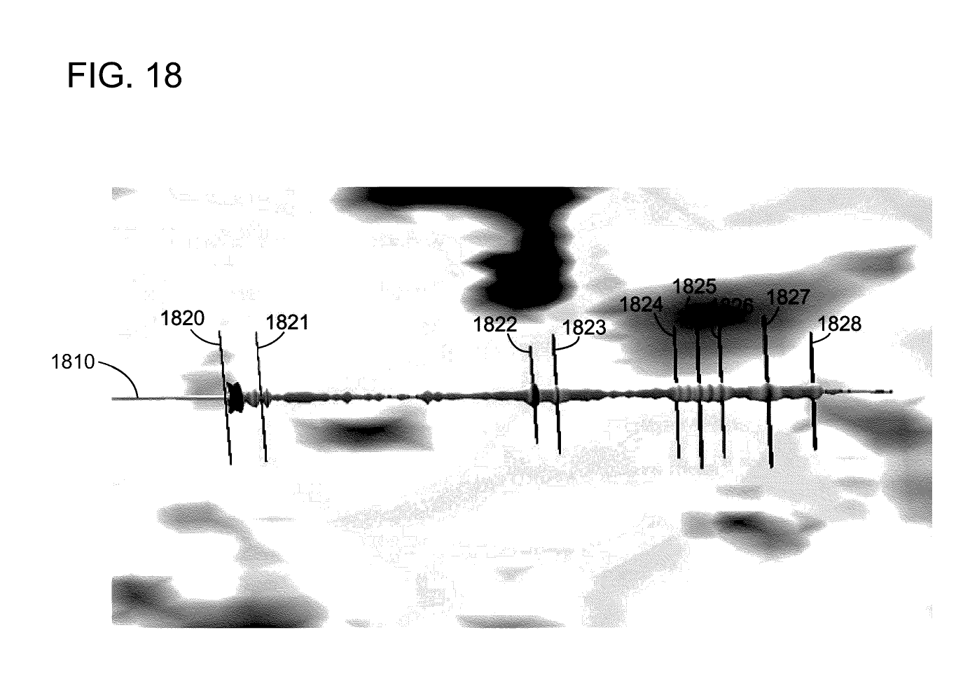

As already pointed out relative to step 160, this 3D model may be further improved using the calibrated well logs and the composition information of horizontal drill cuttings from the wells. For example, FIG. 17 exemplifies composition information for a horizontal drill cutting. FIG. 18 (which is a cross-section through the underground formation, with nuances of gray representing different values of a brittleness attribute) illustrates the impact of the more accurate and dense information provided by the calibrated well log 1810 and horizontal drill cuttings 1820-1828. Different from the conventional approach, this data-processing phase enables higher resolution and accuracy of well logs and composition information from the horizontal drill cuttings to percolate and thus enhance the approximate properties evaluation based on the seismic response.

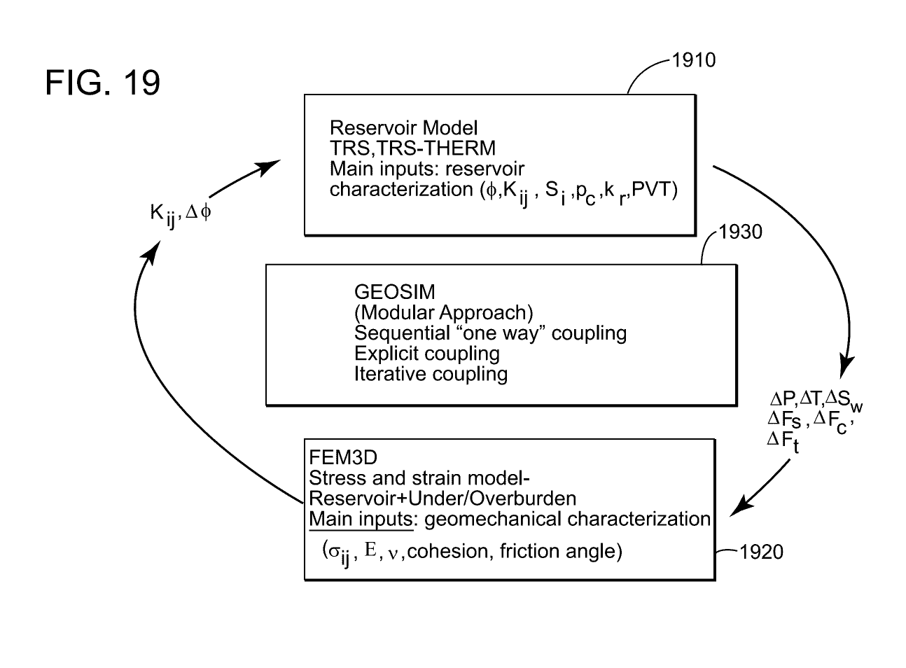

The resulting 3D model may then be used to perform 3D coupled flow and geomechanical simulations to predict the evolution of structure and properties inside the underground volume for different oil and/or gas production scenarios. FIG. 19 illustrates coupled flow and geomechanical simulations looping between a reservoir modeling 1910 based on reservoir characterization, a stress and strain modeling 1920 of the oil and/or gas reservoir, underburden and overburden volumes related to the oil and/or gas reservoir. The reservoir modeling may have as inputs porosity (φ), a permeability tensor (Kᵢⱼ), water saturation (Sᵢ), capillary pressure (p_{c}), relative permeability (kᵣ), and a description of fluid behavior with pressure and temperature (PVT), and may output changes in pressure (ΔP), in temperature (ΔT) and in water saturation (ΔS_{w}), as well as changes in the strength envelope of the materials (ΔFₛ, ΔF_{c}, ΔFₜ, which are limits for shear, compressional or tensile failure caused by reservoir evolution). The stress and strain modeling may have as inputs reservoir modeling's outputs and additional geomechanical properties such as the stress tensor (σᵢⱼ, obtained from seismic data or calculated using density), Young module (E), Poisson ratio (v), cohesion, friction angle and outputs changes in permeability and porosity. The flow and geomechanical simulations may be coupled sequentially, explicitly or iteratively within a computational shell 1930 to allow optimizing of oil and/or gas extraction from the oil and/or gas reservoir.

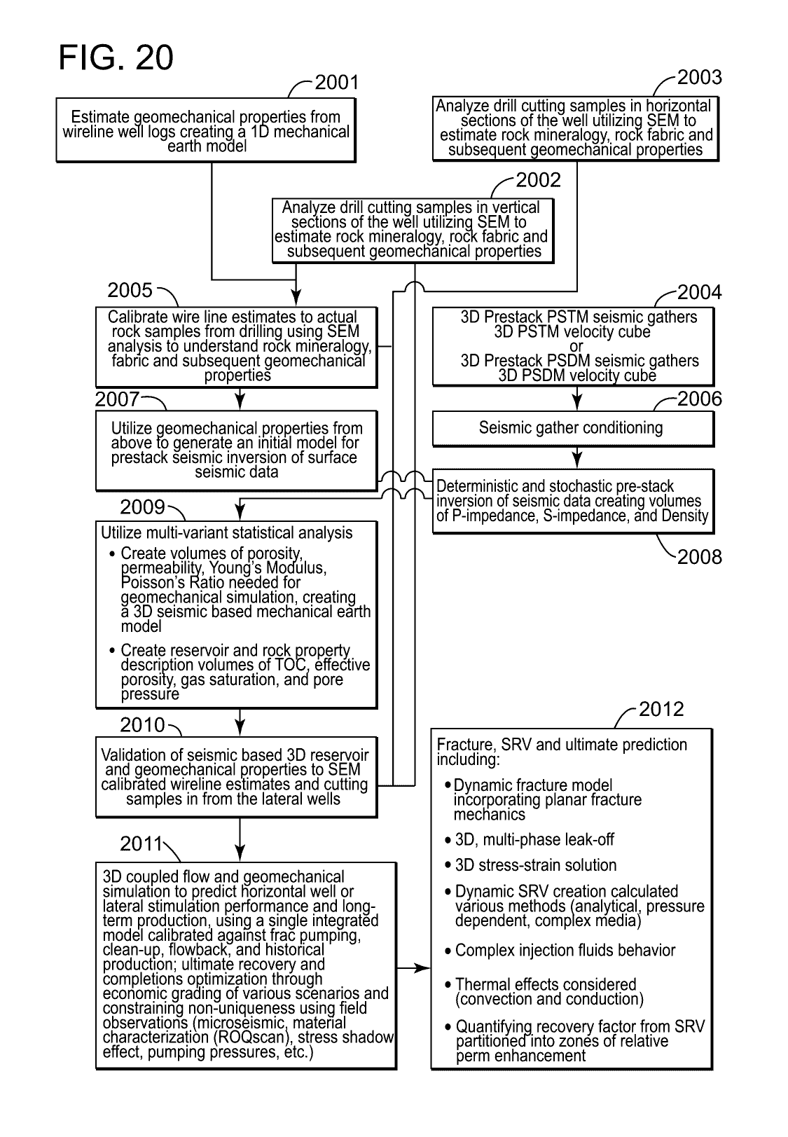

FIG. 20 is a data flow diagram according to an embodiment. At 2001, estimates of geomechanical properties are acquired from well logs to generate a 1D (depth) model of the underground formation. Composition information of the drill cuttings in the well's vertical sections is obtained using SEM at 2002. Composition information includes the results of rock mineralogy, rock fabric and geomechanical properties. Similar composition information is obtained for the drill cutting samples in the well's horizontal sections at 2003. At 2004, seismic data is acquired, migrated and grouped in seismic gathers. The seismic gathers are conditioned at 2006.

The data obtained at 2001, 2002 and 2003 may then be used to calibrate the well data at 2005 before generating an initial model of the underground formation at 2007. This initial model is used as a start point for the deterministic and stochastic inversions at 2008.

The result of the inversion and the calibrated well log data is used in a multi-variant statistical analysis at 2009 to generate a 3D seismic-based mechanical properties model of the underground formation. This model is refined at 2010 using the calibrated well logs and composition information of the horizontal drill cuttings. The refined 3D seismic-based mechanical properties model of the underground formation is then used in 3D coupled flow and geomechanical simulations at 2011 to predict the underground formation's evolution for different production scenarios. These simulations may predict: dynamic fractures (modeled using planar fracture mechanics), a 3D multi-phase leak-off, 3D stress-strain solutions, dynamic simulated reservoir volume (SRV), complex injection fluid behavior, thermal effects, quantifying recovery factor from fracture treatment and SRV, etc.

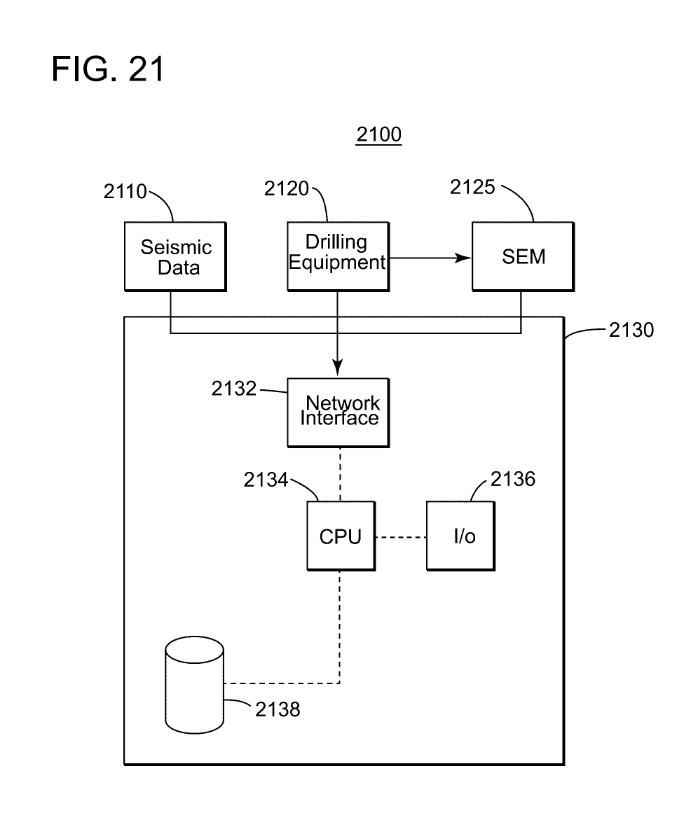

A system 2100 for studying oil and gas recovery from an underground volume including an oil and/or gas reservoir according to an embodiment is schematically illustrated in FIG. 21. System 2100 includes a seismic survey arrangement 2110 configured to acquire seismic data related to the underground volume, and drilling equipment 2120 configured to drill wells inside the underground volume and to retrieve horizontal, deviated and vertical well drill cuttings at predetermined locations. The seismic survey and drilling equipment is well-known. The horizontal, deviated and vertical well drill cuttings may be analyzed, for example, using SEM 2125 to produce composition information.

System 2100 further includes a seismic data-processing apparatus 2130. Seismic data-processing apparatus 2130 includes an interface 2132 configured to obtain the seismic data, well logs of the wells and composition information of the horizontal and vertical drill cuttings. A central processing unit (CPU) 2134 including one or more processors then processes the seismic data using the well logs calibrated based on the composition information to generate a 3D seismic-based mechanical properties model of the underground volume, and to predict the evolution of structure and properties inside the underground volume, for different oil and/or gas production scenarios using this 3D model. A manner (e.g., techniques, equipment, locations) of recovering the oil and gas may then be designed using results predicted for the different oil and/or gas production scenarios.

Seismic data-processing apparatus 2130 may also include an I/O interface 2136 enabling a specialist to visualize results of data processing and/or to control parameters of the data processing. Apparatus 2130 may also include a data storage unit 2138, which may store the seismic data, well logs of the wells and composition information of the horizontal, deviated and vertical well drill cuttings, and results of the data processing and software (executable codes) usable by CPU 2134.

In other words, data-storage unit 2138 may store executable codes which, when executed by the CPU, make it perform methods according to various embodiments. Suitable storage devices include magnetic media such as a hard disk drive (HDD), solid-state memory devices including flash drives, ROM, RAM and optical media. Hardware, firmware, software or a combination thereof may be used to perform the various steps and operations described herein.

The embodiments disclosed in this section provide methods, a system and software for processing seismic data using well logs and composition information of vertical, deviated and horizontal well drill cuttings. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flowcharts provided in the present application may be implemented in a computer program, software or firmware tangibly embodied in a computer-readable storage medium for execution by a geophysics-dedicated computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for modeling geomechanical properties in an underground volume including an oil and/or gas reservoir, the method comprising:
obtaining seismic data acquired with sensors placed to probe the underground volume, well logs of wells drilled inside the underground volume, and composition information of horizontal, deviated and vertical drill cuttings from the wells;
calibrating the well logs using the composition information of horizontal, deviated and vertical drill cuttings from the wells yielding calibrated well logs;
generating an initial structural model of the underground volume based on the calibrated well logs;
inverting the seismic data using the initial structural model to determine values of elastic properties inside the underground volume;
performing a multi-variant statistical analysis using the values of the elastic properties to generate a three-dimensional, 3D, seismic-based mechanical-properties model of the underground volume; and
tuning the 3D seismic-based mechanical-properties model using the calibrated well logs and composition information of the horizontal, deviated and vertical drill cuttings.

2. The method of claim 1, further comprising:
performing 3D coupled flow and geomechanical simulations using the 3D seismic-based mechanical properties model, to predict evolution of structure and properties inside the underground volume, for different oil and/or gas production scenarios.

3. The method of claim 2, wherein the coupled flow and geomechanical simulations include looping between
a reservoir modeling based on reservoir characterization, and
a stress and strain modeling of the oil and/or gas reservoir, under-burden and over-burden volumes related to the oil and/or gas reservoir.

4. The method of claim 2, further comprising:
optimizing oil and/or gas extraction from the oil and/or gas reservoir based on results of the coupled flow and geomechanical simulations.

5. The method of claim 1, wherein the seismic data is pre-stacked, migrated and subjected to seismic gather conditioning before the inverting.

6. The method of claim 5, wherein the seismic gather conditioning removes noise from the pre-stacked migrated seismic data using one or more of following techniques: angle muting, random noise attenuation, high density anisotropic velocity estimation, multiples attenuation, filtering, offset angle conversion, and residual time shift.

7. The method of claim 1, wherein the inverting is deterministic and/or stochastic, and the elastic properties include S-impedance, P-impedance and density.

8. The method of claim 1, wherein the composition information is obtained using scanning electron microscopy, SEM.

9. The method of claim 1, further comprising:
inverting the seismic data using the improved 3D seismic-based mechanical model of the volume to update the values of the elastic properties inside the underground volume;
re-iterating the multi-variant statistical analysis using the updated values of the elastic properties inside the underground volume and the well logs to obtain an updated 3D seismic-based mechanical model of the underground volume; and
improving the updated 3D seismic-based mechanical model using the well logs calibrated using the composition information for the horizontal and the vertical drill cuttings.

10. A computer-readable medium containing computer-executable code that when read by a computer causes the computer to perform a method for modeling geomechanical properties in an underground volume including an oil and/or gas reservoir, the method comprising:
obtaining seismic data acquired with sensors placed to probe the underground volume, well logs of wells drilled inside the underground volume, and composition information of horizontal, deviated and vertical drill cuttings from the wells;
calibrating the well logs using the composition information of horizontal, deviated and vertical drill cuttings from the wells yielding calibrated well logs;
generating an initial structural model of the underground volume based on the calibrated well logs;
inverting the seismic data using the initial structural model to determine values of elastic properties inside the underground volume;
performing a multi-variant statistical analysis using the values of the elastic properties to generate a three-dimensional, 3D, seismic-based mechanical-properties model of the underground volume; and
tuning the 3D seismic-based mechanical-properties model using the calibrated well logs and composition information of the horizontal, deviated and vertical drill cuttings.

11. The computer-readable medium of claim 10, wherein the method further comprises:
performing 3D coupled flow and geomechanical simulations using the improved 3D seismic-based mechanical model, to predict evolution of structure and properties inside the underground volume, for different oil and/or gas production scenarios.

12. The computer-readable medium of claim 11, wherein the coupled flow and geomechanical simulations include looping between
a reservoir modeling based on reservoir characterization, and
a stress and strain modeling of the oil and/or gas reservoir, under-burden and over-burden volumes related to the oil and/or gas reservoir.

13. The computer-readable medium of claim 11, wherein the method further comprises:
optimizing oil and/or gas extraction from the oil and/or gas reservoir based on results of the coupled flow and geomechanical simulations.

14. The computer-readable medium of claim 10, wherein the seismic data is pre-stacked, migrated and subjected to seismic gather conditioning before the inverting.

15. The computer-readable medium of claim 14, wherein the seismic gather conditioning removes noise from the pre-stacked migrated seismic data using one or more of following techniques: angle muting, random noise attenuation, high density anisotropic velocity estimation, multiples attenuation, filtering, offset angle conversion, and residual time shift.

16. The computer-readable medium of claim 10, wherein the inverting is deterministic and/or stochastic, and the elastic properties include S-impedance, P-impedance and density.

17. The computer-readable medium of claim 10, wherein the composition information is obtained using scanning electron microscopy, SEM.

18. The computer-readable medium of claim 10, wherein the method further comprises:
inverting the seismic data using the improved 3D seismic-based mechanical model of the volume to update the values of the elastic properties inside the underground volume;
re-iterating the multi-variant statistical analysis using the updated values of the elastic properties inside the underground volume and the well logs to obtain an updated 3D seismic-based mechanical model of the underground volume; and
improving the updated 3D seismic-based mechanical model using the well logs calibrated using the composition information for the horizontal, deviated and the vertical well drill cuttings.

19. A system for studying oil and gas recovery from an underground volume including an oil and/or gas reservoir, the system comprising:
a seismic survey arrangement configured to acquire seismic data related to the underground volume;
drilling equipment configured to drill wells inside the underground volume and to retrieve horizontal, deviated and vertical drill cuttings at predetermined locations; and
a seismic data processing apparatus configured
to obtain the seismic data, well logs of the wells and composition information of the horizontal, deviated and vertical drill cuttings,
to process the seismic data using the well logs calibrated based on the composition information to generate a 3D seismic-based mechanical properties model of the underground volume, and
to predict evolution of structure and properties inside the underground volume, for different oil and/or gas production scenarios using the 3D seismic-based mechanical model,
wherein a manner of recovering the oil and gas is designed using results predicted for the different oil and/or gas production scenarios.

20. The system of claim 19, wherein the seismic data processing apparatus processes the seismic data by:
generating an initial structural model of the underground volume based on the well logs;
inverting the seismic data using the initial structural model to determine values of elastic properties inside the underground volume;
performing a multi-variant statistical analysis using the values of the elastic properties and the well logs to generate a three-dimensional, 3D, seismic-based mechanical model of the underground volume; and
refining the 3D seismic-based mechanical model using the well logs calibrated based on the composition information of the horizontal, deviated and vertical drill cuttings.
